(19) United States
(12) Patent Application Publication
(10) Pub. No.: US 2011/0150014 A1
(43) Pub. Date: Jun. 23, 2011

(54) ANALOG TEMPERATURE CONTROL FOR TUNABLE LASERS

(76) Inventors: Andrew Daiber, Emerald Hills, CA (US); Mark Stephen Rice, San Jose, CA (US); Timothy L. Robertson, Belmont, CA (US)

(21) Appl. No.: 12/540,946

(22) Filed: Aug. 13, 2009

(51) Int. Cl. H01S 3/10; H01S 3/00

(52) U.S. Cl. 372/20; 372/38.02

(57) ABSTRACT

An analog circuit including a voltage divider for providing a first voltage corresponding to an actual temperature of said thermal tuning element of the laser; an analog comparator generating an analog output current for comparing the first voltage with a reference voltage, the reference voltage being representative of a temperature of said thermal tuning element of the laser corresponding to a desired wavelength of the laser; and a heating element thermally coupled to said thermal tuning element, wherein the analog comparator increases said analog current to the heating element, when the first voltage is less than the reference voltage; and decreases said analog current to the heating element, when the first voltage is larger than the second reference voltage.

### FIELD OF THE INVENTION

This invention relates to the general area of optical telecommunication, and more specifically to an analog temperature control circuit for thermally tunable lasers.

### BACKGROUND

The demand for tunable lasers for optical communication is increasing across the world. By wavelength division multiplexing (DWDM), multiple separate data can be transmitted simultaneously in a single optical fiber connection and therefore utilizing an existing fiber optic capacity or a substantially small number of optical fiber connections to transmit more data streams. This requires that the output of the laser that generates the optical signals be modulated at a specific frequency or wavelength for the optical channel. In other words, the laser has to be accurately tunable to different frequencies.

An effective laser-tuning method must generate a stable, single mode output at selectable frequencies or wavelengths. For thermally tunable lasers, this means that the temperature needs to be accurately controlled, with minimal sensitivity to temperature changes.

There are various digital temperature control circuits for controlling the temperature of thermally tunable elements. However, these digital circuits are complex and costly.

Therefore, there is a need for a simple and accurate analog temperature control circuit for thermally tunable lasers.

### SUMMARY

In some embodiments, the present invention is a method for thermally tuning a laser, which includes a thermal tuning element. The method includes: generating a first electrical parameter representative of a temperature of said thermal tuning element of the laser corresponding to a desired wavelength of the laser; generating a second electrical parameter corresponding to an actual temperature of said thermal tuning element; comparing the first electrical parameter with the second electrical parameter by an analog comparator having an analog output; and controlling a heating element thermally coupled to said thermal tuning element, by the analog output of the analog comparator.

The first electrical parameter may be a voltage across a resistive temperature device. In some embodiments, controlling the heating element includes increasing a current supplied from the analog output to the heating element, when the first electrical parameter is less than the second electrical parameter; and decreasing said current to the heating element, when the first electrical parameter is larger than the second electrical parameter.

In some embodiments, the present invention is an analog circuit for thermally tuning a laser having a thermal tuning element. The analog circuit includes a voltage divider for providing a first voltage corresponding to an actual temperature of said thermal tuning element of the laser; an analog comparator generating an analog output current for comparing the first voltage with a reference voltage, the reference voltage being representative of a temperature of said thermal tuning element of the laser corresponding to a desired wavelength of the laser; and a heating element thermally coupled to said thermal tuning element, wherein the analog comparator increases said analog current to the heating element, when the first voltage is less than the reference voltage; and decreases said analog current to the heating element, when the first voltage is larger than the second reference voltage.

In some embodiments, the thermal tuning element is an optical filter or an etalon and the voltage divider includes a resistive temperature device (RTD).

### BRIEF DESCRIPTION OF THE DRAWINGS

FIG. 1 is an exemplary block diagram for a thermally tunable laser, according to some embodiments of the present invention.

FIG. 2 is an exemplary circuit diagram for an analog temperature controller, according to some embodiments of the present invention.

FIG. 3 is another exemplary circuit diagram for an analog temperature controller, according to some embodiments of the present invention.

FIG. 4 is an exemplary circuit diagram for a DAC attenuator circuit, according to some embodiments of the present invention.

FIGS. 5A, to 5C are exemplary timing diagrams, according to some embodiments of the present invention.

### DETAIL DESCRIPTION

In some embodiments, the present invention is an analog temperature feedback control circuit for thermally tunable lasers.

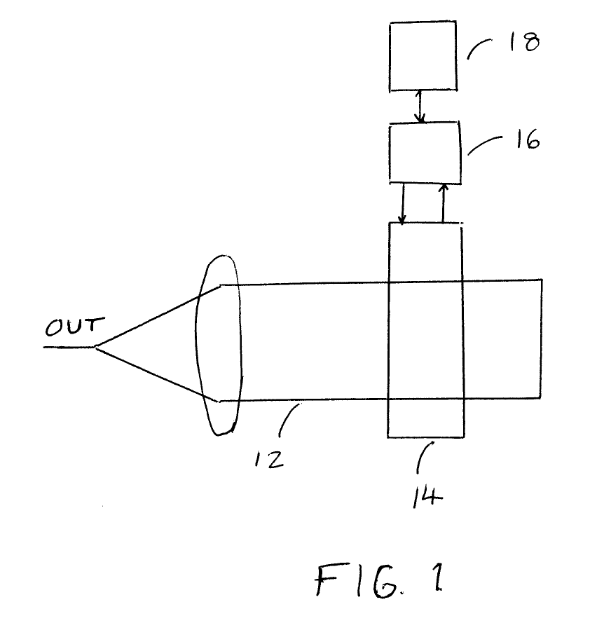

FIG. 1 is a simplified exemplary block diagram for a thermally tunable laser, according to some embodiments of the present invention. As depicted, thermally tunable laser 12 includes a thermally tuning element 14. The thermally tuning element 14 is controlled by the analog control circuit 16. Analog control circuit 16 ensures a constant temperature (within a tolerance range) at the thermally tuning element 14 based on a specific wavelength or frequency dictated by the controller 18. For example, in response to a system command, the controller 18 adjusts the tuning of the thermally tuning element 14, which then generates a lasing mode corresponding to the desired wavelength or frequency.

In some embodiments, the thermally tuning element may be one or more optical tuning filter elements that comprise one or more etalons, gratings, prisms or other elements capable of providing temperature feedback to the analog control circuit 16 at a wavelength selected by the controller 18. Typically, tuning takes place by changing the optical path length of each etalon by changing the temperature of the etalons. In some embodiments, the etalons are configured such that the respective free spectral ranges of the etalons are slightly different. This enables transmission signal peaks to be aligned under a Vernier tuning technique similar to that employed by a Vernier scale. A more detailed description of various components of a thermally tunable laser is provided in U.S. Pat. No. 7,257,142, the entire contents of which is hereby expressly incorporated by reference.

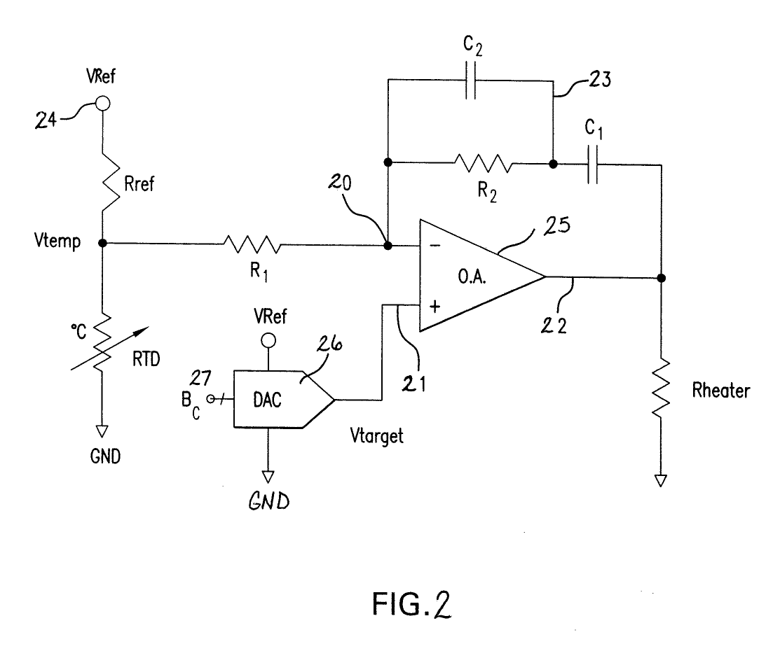

FIG. 2 is an exemplary circuit diagram for an analog temperature controller, according to some embodiments of the present invention. As shown, an analog operational amplifier (opamp) 25 is connected to node 20 and 21 at its inputs and to node 22 at its output. Opamp 25 behaves as an analog comparator by comparing the two inputs at input nodes 20 and 21, and generates an output (current) accordingly. The positive input at node 21 is connected to output of a digital to analog converter (DAC) 26. The negative input node 20 of the opamp 25 is connected to a voltage (current) that is a function of the temperature. The opamp 25 compares the output of DAC 26 to the temperature sensitive node 20. Depending on the comparison results, the opamp increases, decreases or keeps the voltage (temperature) of Rheater.

The voltage (current) at the input node 20 is generated by a reference voltage Vref and a voltage divider. The voltage of the reference voltage Vref is divided by two resistors Rref and RTD. Since RTD is a temperature sensitive resistor, the voltage Vtem (and the current through RTD) is also a function of the temperature of the thermally tuning element.

RTD resistor behaves as a temperature sensor that senses the temperature of the thermal tuning element, such as an optical filter and generates a voltage Vtemp accordingly. As the temperature of the thermal tuning element decreases, the resistance of RTD increases resulting in a larger Vtarget (current) at the input node 21. As a result of the increased voltage at input node 21, the output current at output node 22 increases causing the temperature of Rheater to rise. Rheater is thermally coupled to the RTD (thermal tuning element). The increase in temperature of Rheater results in a similar increase in the temperature of the thermal tuning element.

Conversely, when the temperature of the thermal tuning element increases, the resistance of RTD decreases resulting in a smaller Vtarget (current) at the input node 21. As a result of the decreased voltage at input node 21, the output current at output node 22 is reduced and therefore the temperature of the heating element, Rheater decreases. The decrease in temperature of Rheater causes in a similar decrease in the temperature of the thermal tuning element.

In some embodiments, DAC 26 is controlled by a controller (e.g., a microprocessor), which sets the value of Vtarget based on the desired operation frequency of the tunable laser. That is, the value of Vtarget sets the steady state temperature of the thermal tuning element and thus causes the laser to modulate at a specific frequency or wavelength. In some embodiments, DAC 26 is supplied with the same Vref to minimize the mismatch and variation between the Vtem and Vtarget due to elements other than the RTD temperature.

The gain and frequency characteristics of the opamp 25 are determined by R1, C1 and R2, while the frequency response (transfer function) and the zero location of the frequency response are determined by R2 and C1. If the dominant thermal time constant of the thermal tuning element is matched by the opamp's zero location, the opamp will be operating in the linear region. In some embodiments, the values of R1, C1 and R2 are selected such that the open loop transfer function has about 90 degrees of phase for a wide range of frequencies.

In other words, the DAC generates a first electrical parameter, for example, Vtarget or a respective current, representative of a temperature of the thermal tuning element RTD that corresponds to a desired wavelength of the laser. The circuit also generates a second electrical parameter, for example, Vtemp (or a respective current through R1) corresponding to an actual temperature of RTD. The analog opamp compares the first electrical parameter with the second electrical parameter, and controls a heating element (for example, Rheater) thermally coupled to the thermal tuning element RTD.

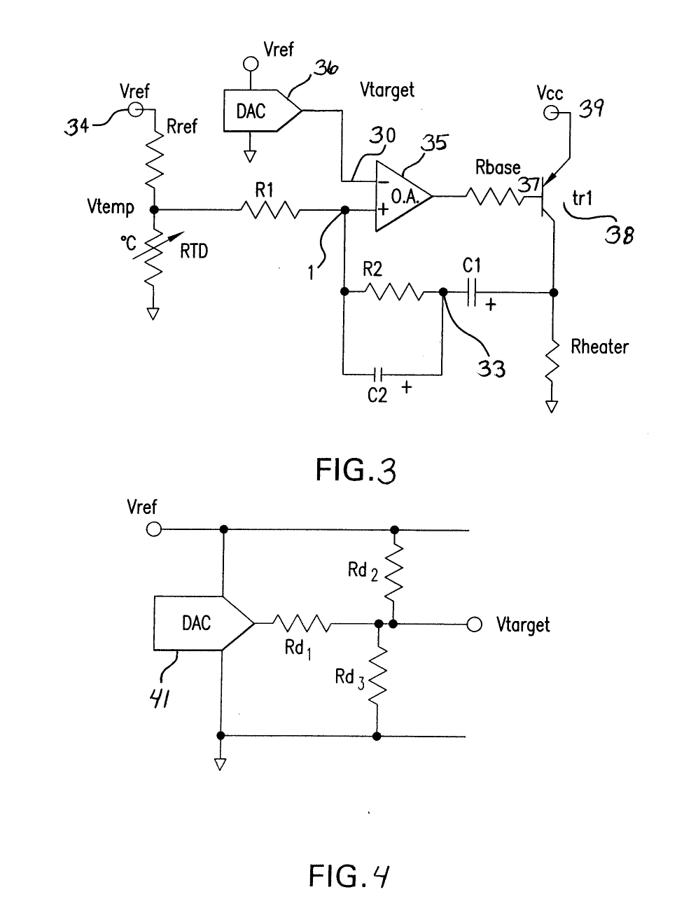

FIG. 3 is another exemplary circuit diagram for an analog temperature controller, according to some embodiments of the present invention. In these embodiments, an amplifying stage including a PNP transistor 38 and a resistor Rbase is added to the output node 32 of the opamp 35 to amplify the output. This way, the amplifying stage increases the current source capability of the opamp 35 and thus reduces the required sensitivity of RTD to the ambient temperature of the thermal tuning element. Here, since the amplifying stage is also an inverting stage, the inputs to the opamp input nodes 30 and 31 are switched, with respect to those (20 and 21) depicted in FIG. 2.

FIG. 4 is an exemplary circuit diagram for a DAC attenuator circuit, according to some embodiments of the present invention. As shown, the output of the DAC 41 is attenuated by the three resistors Rd1, Rd2, and Rd3. This way, the resolution requirement for the DAC 41 is reduced. Also, the attenuator attenuates the undesirable behavior of the DAC, such as clamping, vast voltage swings, settling time, and the like.

Some Ser. No. 11/481,756 above the sled exemplary values for the resistors and capacitors of FIGS. 2 and 4 may be Rd1=Rd2=Rd3=3.3 k ohm, R1=4.99 k, R2=301 k Rref=925 Ohm, Rheater=about 50 ohm, RTD=600 to 100 ohms at 25 C, C1=10 mF, and C2=100 pF.

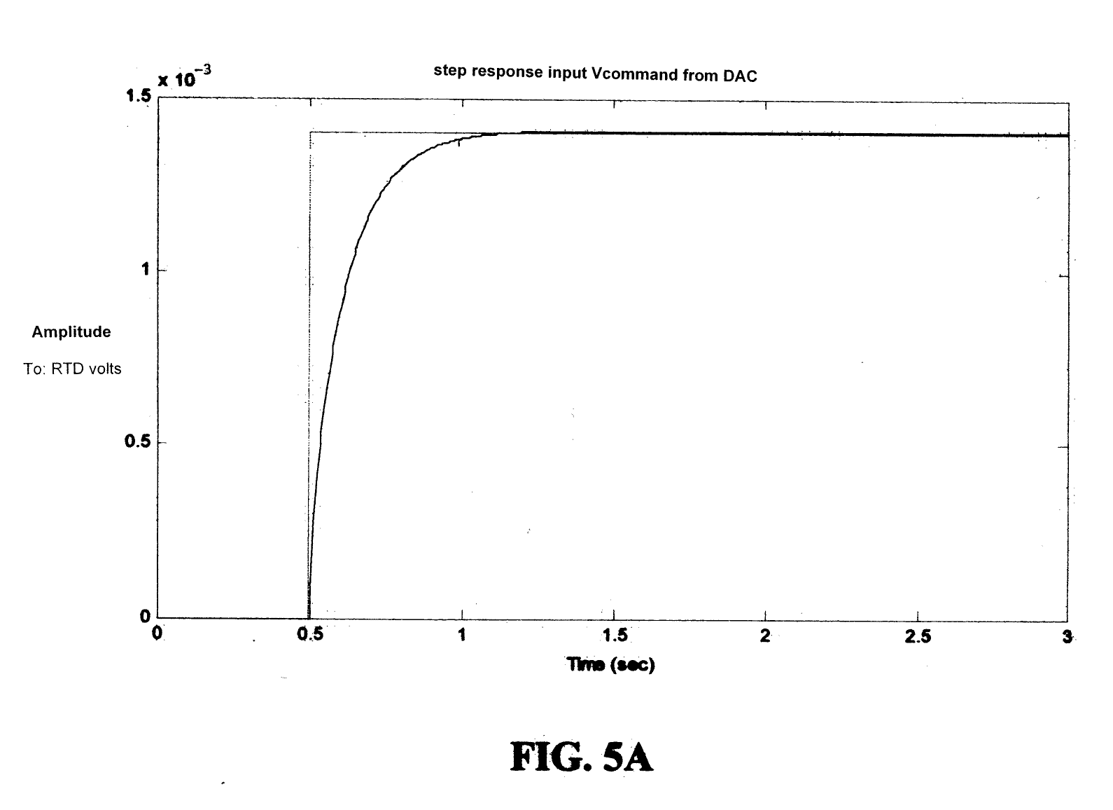

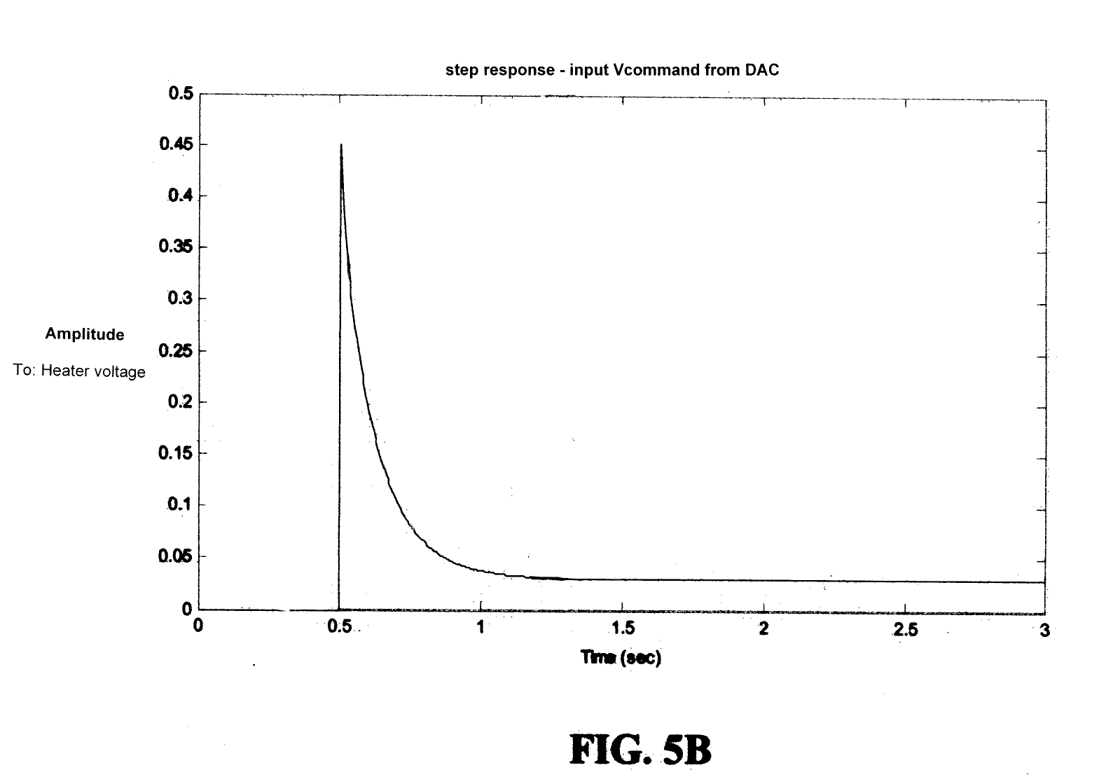

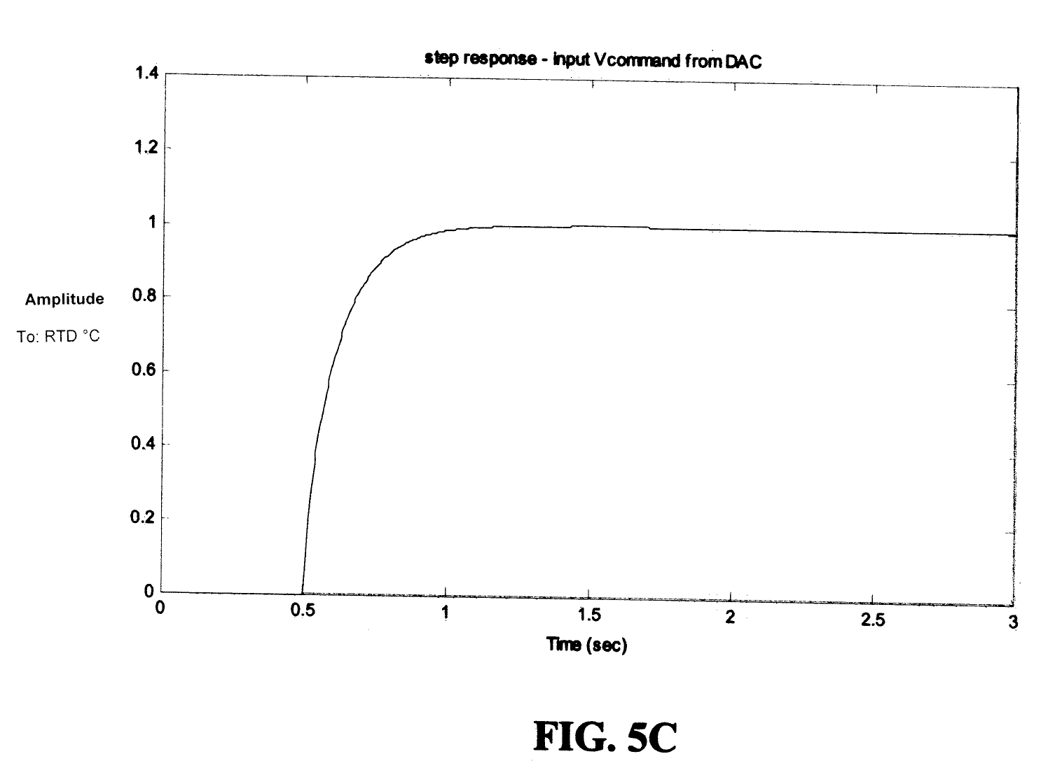

FIGS. 5A, to 5C are exemplary timing diagrams, according to some embodiments of the present invention. FIG. 5A depicts a step response of the analog temperature controller, according to some embodiments of the present invention. The solid trace corresponds to the timing of, for example, node 21 (Vtarget) in FIG. 2. The dashed trace corresponds to the timing of Vtemp in FIG. 2. FIG. 5B shows the timing of the Rheater voltage (for example, node 22 in FIG. 2). FIG. 5C shows the trajectory of the temperature of the thermally tuning element.

These timing diagrams show deviations from an equilibrium point. The operating point with the filters could be about 20° C. above the sled (or package) temperature. Suppose the sled was at 40° C. and the filter at 60.0° C. Accordingly, close to 10 mW is needed to maintain this temperature. With a 50 Ω heater, an equilibrium with 0.707 volts on the heater can be achieved. Suppose target and Vtemp were at 1.2 Volts. Then, the 1.4 mV step on Vtarget would raise the Vtarget to 1.4014 volts and Vtemp would follow. As a result, the temperature of the thermally tuning element would move up to 61.0° C. The Rheater voltage then would have a spike up to 1.15 volts, before settling down to about 0.75 volts. This spike provides the heat to move the temperature up by 1° C.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope of the appended claims. For example, although the present invention is described by showing

What is claimed is:

1. A method for thermally tuning a laser having a thermal tuning element, the method comprising:
generating a first electrical parameter representative of a temperature of said thermal tuning element of the laser corresponding to a desired wavelength of the laser;
generating a second electrical parameter corresponding to an actual temperature of said thermal tuning element;
comparing the first electrical parameter with the second electrical parameter by an analog comparator having an analog output; and
controlling a heating element thermally coupled to said thermal tuning element, by the analog output of the analog comparator.

2. The method of claim 1, wherein the first electrical parameter is a voltage across a resistive temperature device.

3. The method of claim 1, wherein said controlling comprises increasing a current supplied from the analog output to the heating element, when the first electrical parameter is less than the second electrical parameter; and decreasing said current to the heating element, when the first electrical parameter is larger than the second electrical parameter.

4. The method of claim 1, further comprising changing said first electrical parameter for tuning the laser to a second desired wavelength.

5. The method of claim 1, wherein said thermal tuning element comprises two etalons, the method further comprising selecting a configurations of said two etalons such that respective free spectral ranges of said etalons are slightly different to align transmission peaks.

6. The method of claim 1, further comprising amplifying the output of the analog comparator and controlling the heating element by the amplified analog output of the analog comparator.

7. An analog circuit for thermally tuning a laser having a thermal tuning element comprising:
a voltage divider for providing a first voltage corresponding to an actual temperature of said thermal tuning element of the laser;
an analog comparator generating an analog output current for comparing the first voltage with a reference voltage, the reference voltage being representative of a temperature of said thermal tuning element of the laser corresponding to a desired wavelength of the laser; and
a heating element thermally coupled to said thermal tuning element, wherein the analog comparator increases said analog current to the heating element, when the first voltage is less than the reference voltage; and decreases said analog current to the heating element, when the first voltage is larger than the second reference voltage.

8. The analog circuit of claim 7, wherein said thermal tuning element is an optical filter.

9. The analog circuit of claim 7, wherein said thermal tuning element is an etalon.

10. The analog circuit of claim 7, wherein said voltage divider includes a resistive temperature device.

11. The analog circuit of claim 7, further comprising:
a first resistor coupled to an inverting input of the analog comparator and the voltage divider;
a second resistor couple to the inverting input of the analog comparator and an output of the analog comparator; and
a first capacitor couple to the inverting input of the analog comparator and an output of the analog comparator in parallel with the second resistor.

12. The analog circuit of claim 7, further comprising a current amplifier coupled to an output of the analog comparator for amplifying said analog current to the heating element.

13. The analog circuit of claim 7, further comprising a programmable digital to analog converter (DAC) for generating said reference voltage.

14. The analog circuit of claim 13, further comprising a voltage attenuator coupled to an output of the DAC for attenuating said reference voltage.

15. A system for thermally tuning a laser having a thermal tuning element comprising:
means for generating a first electrical parameter representative of a temperature of said thermal tuning element of the laser corresponding to a desired wavelength of the laser;
means for generating a second electrical parameter corresponding to an actual temperature of said thermal tuning element;
means for comparing the first electrical parameter with the second electrical parameter by an analog comparator having an analog output; and
means for controlling a heating element thermally coupled to said thermal tuning element, by the analog output of the analog comparator.

16. The system of claim 15, wherein the first electrical parameter is a voltage across a resistive temperature device.

17. The system of claim 15, wherein said means for controlling comprises means for increasing a current supplied from the analog output to the heating element, when the first electrical parameter is less than the second electrical parameter; and means for decreasing said current to the heating element, when the first electrical parameter is larger than the second electrical parameter.

18. The system of claim 15, further comprising means for changing said first electrical parameter for tuning the laser to a second desired wavelength.

19. The system of claim 15, wherein said thermal tuning element comprises two etalons, the system further comprising means for selecting a configurations of said two etalons such that respective free spectral ranges of said etalons are slightly different to align transmission peaks.

20. The system of claim 15, further comprising means for amplifying the output of the analog comparator and controlling the heating element by the amplified analog output of the analog comparator.
